(19) United States
(12) Patent Application Publication
(10) Pub. No.: US 2022/0019868 A1
(43) Pub. Date: Jan. 20, 2022

(54) PRIVACY-PRESERVING REPRESENTATION MACHINE LEARNING BY DISENTANGLEMENT

(71) Applicant: SAP SE, Walldorf (DE)

(72) Inventors: Tassilo Klein, Berlin (DE); Moin Nabi, Berlin (DE)

(21) Appl. No.: 16/933,584

(22) Filed: Jul. 20, 2020

(51) Int. Cl. G06N 3/04; G06F 21/62; G06N 20/00; G06N 3/08; G06K 9/62

(52) U.S. Cl. CPC G06N 3/04; G06F 21/6245; G06K 9/6256; G06N 3/084; G06N 20/00

(57) ABSTRACT

In an example embodiment, a solution is provided to learn representations of a dataset in order to minimize the amount of information which could be revealed about the identity of each client. Specifically, one goal is to enable the system to learn relevant properties (e.g., regular labels that are non-privacy infringing) of a dataset as a whole while protecting the privacy of the individual contributors (private labels, which can identify a client). The database may be held by a trusted server that can learn privacy-preserving representations, such as by sanitizing the identity-related information from a latent representation.

### TECHNICAL FIELD

This document generally relates to machine learning. More specifically, this document relates to privacy-preserving representation machine learning by disentanglement.

### BACKGROUND

Machine learning may be used in a variety of computerized tasks. Deep Neural Networks (DNN) are one type of machine learning where artificial neurons are linked and multiple layers of such neurons are used to progressively extract higher level features from raw input. DNNs typically rely on large amounts of training data, which limits their usefulness in fields where privacy of data is an issue, such as medical fields. Growing privacy concerns for medical data are a deterrent in the widespread adoption of DNNs for solving problems using medical data.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for creating a privacy-preserving representation of data in accordance with an example embodiment.

FIG. 2 is a block diagram illustrating the representation learning machine learning algorithm in more detail in accordance with an example embodiment.

FIG. 3 is a flow diagram illustrating a method for creating a privacy-preserving representation of data in accordance with an example embodiment.

FIG. 4 is a flow diagram illustrating a method for feeding the labelled training data into a machine learning algorithm to train a representation learning model to compress data in a manner such that private attributes cannot be decompressed, in accordance with an example embodiment.

FIG. 5 is a block diagram illustrating an architecture of software, which can be installed on any one or more of the devices described above.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

As described above, DNNs typically require large amounts of training data that, in certain fields, can create privacy issues. In this regard, many datasets have been released into the public domain that are unintentionally permeated with private information about individuals, raising serious concerns about data privacy. Indeed, attempts at anonymizing data can be reversed by intrepid individuals, and even data that is believed to be nonidentifiable, such as a brain scan using a magnetic resonance imaging (MM) device, can actually be used to identify people. Reliable and accurate privacy preserving methodologies are needed.

One challenge is in designing machine learning algorithms that preserve user privacy while achieving reasonable predictive power. This is even more challenging in the client-server scenario. Here, the clients are supposed to send information to the server, which in turn performs operations such as training for the client. The client's confidential data, however, becomes an issue. Consider a set of clients that aim at collaboratively learning an attribute classifier based on facial image, while protecting the identities of the individuals. Ideally, the trained model will classify non-sensitive attributes (e.g., having glasses or not) with high accuracy, while failing to classify sensitive attributes (e.g., gender, race).

One approach to this privacy issue is to anonymize the data of the clients. This can be achieved by directly obfuscating the private portion(s) of the data and/or adding random noise to the raw data. Consequently, the noise level controls the tradeoff between predictive quality and user privacy. These approaches can associate a privacy budget with all operations on the dataset. Complex training procedures run the risk of exhausting the privacy budget before convergence.

Another possible solution would be to rely on encoded data representation. Here, rather than the client's data, a feature representation of the client's data is transferred to the server instead. Unfortunately, the extracted features may still contain rich information, which can breach user privacy. Specifically, in the case of an image, an attacker can exploit eavesdropped features to reconstruct the raw image, and hence the person in the raw image can be re-identified from the reconstructed image. In addition, the extracted features can also be exploited by an attacker to infer private attributes.

Another solution would be to use federated learning, which collaboratively trains a centralized model while keeping the training data decentralized. The idea behind this strategy is that the clients transfer the training gradients of data to the server instead of the data itself. While such an approach is appealing to train a neural network with data hosted in several clients, it does not allow for the use of a centralized model for making a prediction at test time. Furthermore, transferring the models between clients and servers entails significant data transmission, which considerably prolongs training. Furthermore, averaging the gradients across the clients further slows backpropagation.

These solutions also all involve situations where the private attributes are known a priori. These approaches may fail to prevent privacy attacks when the private information contained in the dataset is not explicitly identified. Some scenarios also defy simple annotation of private content, such as imaging of military and civilian areas. In such scenarios, it is highly desirable to automatically remove content that may be subject to sensitive information. This situation is further aggravated in domains such as low-shot learning with the scarcity of training examples and associated privacy labels, entailing ambiguity with respect to sensitive features (sensitive features being ones that reveal identifying information). Low-shot learning involves training machine learning algorithms with small amounts of training data.

In an example embodiment, a solution is provided to learn representations of a dataset in order to minimize the amount of information which could be revealed about the identity of each client. Specifically, one goal is to enable the system to learn relevant properties (e.g., regular labels that are non-privacy infringing) of a dataset as a whole while protecting the privacy of the individual contributors (private labels, which can identify a client). The database may be held by a trusted server that can learn privacy-preserving representations, such as by sanitizing the identity-related information from a latent representation. Specifically, the decomposition of the latent representation into two latent factors, style and content, may be performed. Style captures the private aspects of the data, whereas content encodes the public part. Thus, it is the public part that is used for training downstream tasks as it can be transferred without compromising privacy. Following this notion, style encodes patterns that are shared among the sample of each client. In contrast, the content encodes information about concepts, which is shared across clients. Ultimately, this implies a disentanglement in the feature space between private features and public features.

It should be noted that while this problem has and will be described in this document in the context of medical data, that is merely one example embodiment as to how the solution can be used. Embodiments are possible for any data that may contain private information or information that can be used to deduce or infer private information.

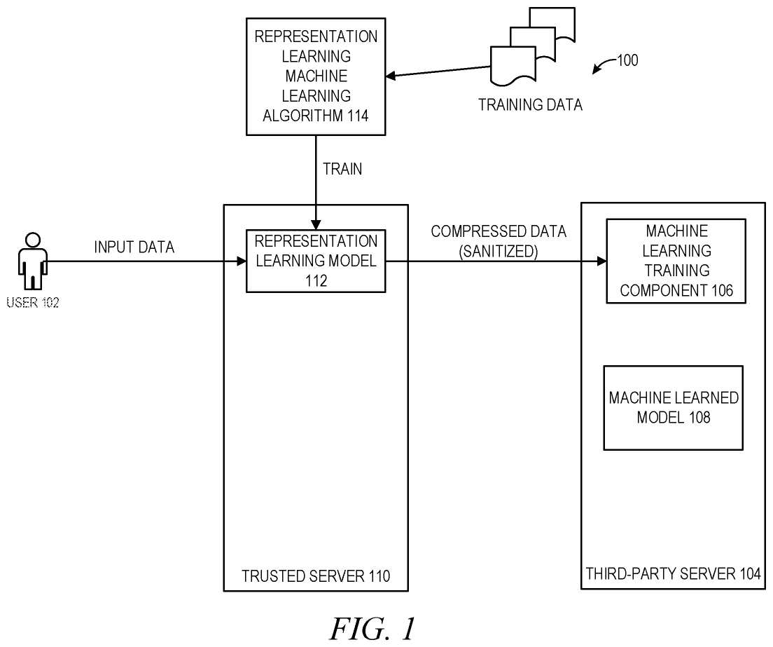

FIG. 1 is a block diagram illustrating a system 100 for creating a privacy-preserving representation of data in accordance with an example embodiment. Here, data obtained from a user 102 would ordinarily be used directly by a third-party server 104, and specifically by a machine learning training component 106 on the third-party server 104 to train a machine learned model 108. Because there is concern, however, that this data may contain, or at least be used to infer, private information (such as private information about the user 102, although, as will be described in more detail below, the private information could be private information about anyone or anything), a trusted server 110 is introduced. The user 102 then passes the data directly to the trusted server 110 and not directly to the third-party server 104. The trusted server 110 uses a representation learning model 112 to create a version of the data that is “privacy-protecting.” This may be, for example, a compressed version of the data that cannot be decompressed in a manner that reveals private information.

It should be noted that while this figure depicts the original data coming directly from the user 102 to the trusted server 110, embodiments are foreseen where one or more components, applications, servers, reside between the user 102 and the trusted server 110 and act to pass the data from the user 102 to the trusted server 110.

The representation learning model 112 may be trained by passing training data to a representation learning machine learning algorithm 114, which then learns the representation learning model 112, as will be described in more detail below.

In one example embodiment, the representation learning machine learning algorithm 114 is a deep neural network built on top of variational autoencoders (VAEs). A VAE comprises two networks, an encoder and a decoder. The encoder maps a data sample to a latent representation, while the decoder maps this representation back to a data space. VAE networks are trained by minimizing a cost function that encourages learning a latent representation, which leads to realistic data synthesis while simultaneously ensuring sufficient diversity in the synthesized data. More particularly, a variational autoencoder uses latent spaces that are, by design, continuous, allowing for easier random sampling and interpolation. Specifically, rather than having the encoder output a vector of size n, it outputs two vectors of size n, one being a vector of means μ and another being a vector of standard deviations σ. These form the parameters of a vector or random variables of length n, with the ith element of μ and σ being the mean and standard deviation of the ith random element from which the sample is obtained, resulting in a sampled encoding that can be passed to the decoder.

Minimizing a cost function that encourages learning a latent representation is achieved by minimizing the distance between input and reconstruction subject to distributional regularization on the latent space. In addition to the VAE entailed cost functions, the loss space may be augmented with additional terms, namely “content classification loss” and “style confusion loss”. In the context of a supervised setup, the former is utilized to enforce for target predictability for a downstream task, such as machine learning on the third-party server 104, while the latter encourages preserving privacy. These two additional terms can enforce disentanglement of the private and public parts of the representation, as well as utilizing a weakly supervised training scenario, where the downstream attributes are not known a priori.

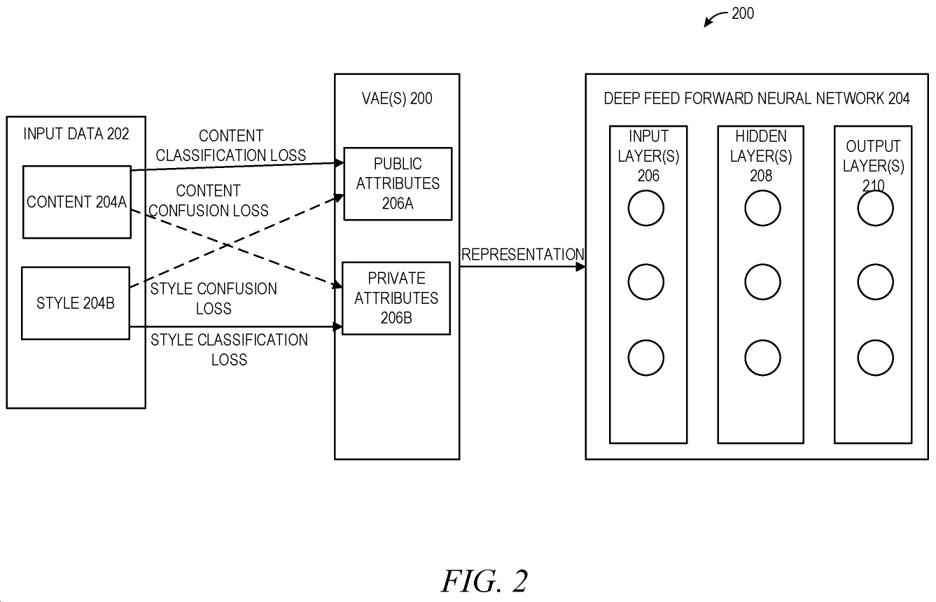

FIG. 2 is a block diagram illustrating the representation learning machine learning algorithm 114 in more detail in accordance with an example embodiment. Here, one or more variable autoencoders 200 map input data 202 to a latent representation z, and then a deep feed forward neural network 204 trains a representational learning model to predict a label y∈Y, defined as y=(z, θ), which is parameterized by θ. The input data 202 may be thought of as containing content (also known as public information) 204A and style (also known as private information) 204B. The one or more variable autoencoders 200 contain additional terms to identify content classification loss (namely, the loss in the predictability of public attributes 206A from the content 204A) and style confusion loss (namely, the loss in predictability of private attributes 206B from the style 204B). The deep feed forward neural network 204 is then trained as a representational learning model to maximize the style confusion loss while minimizing the content classification loss.

It should be noted that, for understanding, this figure also depicts content confusion loss and style classification loss, but these losses are not relevant to the deep feed forward neural network and thus it is not necessary that the VAE(s) 200 consider them.

The deep feed forward neural network 204 contains at least one input layer 206, at least one hidden layer 208, and at least one output layer 210. Each of the at least one hidden layer 208 contains one or more nodes called perceptron, which is a neuron, that uses a nonlinear activation function.

Thus, the privacy-preserving representation learning problem is solved by learning disentangled representations in a client-server setup. Further, the disentangled representations are learned from the client-level supervision by adding two novel loss terms to a VAE.

In an example embodiment, representations are learned that, beyond being private for a variety of sensitive attributes, can be adapted compositionally for predicting many test-time task labels. A two-stage client-server learning model may be utilized, wherein in the first stage a private representation of the data is learned, and in the second stage the actual downstream task is performed. This approach involves learning a disentangled representation that allows for sanitization of latent representation in terms of privacy. Specifically, the information about sensitive and non-sensitive attributes for separate subspaces may be isolated, while ensuring that the latent space factorizes these subspaces independently. Depending on the assumptions related to the downstream task condition (if it is known a priori or not), several variants may be utilized. The cases where the downstream task is known a priori (supervised disentanglement) can be considered separately from the cases where the downstream task is not known a priori (weakly-supervised disentanglement).

Ultimately, the goal is to learn a representation z∈ [symbol] ^{m} of data x∈k with z=ƒ(x) and m<<k, which decomposes into two parts z_{*}∈ [symbol] ^{m}, z_{•}∈ [symbol] ⁿ=z where, without loss of generality, it may be assumed that m=n, representing the public and private information, respectively. Therefore, the public component should reveal as little as possible about sensitive information. That is why the function ƒ is used to learn the representation such that z_{*}⊥z_{•}. Ideally, this representation has a strong utility for a multitude of downstream tasks. To this end, a VAE is used in combination with regularization terms. The VAE serves the purpose that the input is compressed in a meaningful fashion. However, VAE alone does not consider learning a representation that is useful for downstream tasks or puts restrictions in terms of privacy of attributes or latent factors. Attaching additional constraints on the latent representation is technically challenging, and it becomes even more challenging if the downstream task is not known a priori.

An example embodiment makes use of a VAE architecture that assumes isotropic Gaussian as latent prior p(z)= [symbol] (0,I). Optimization of VAE entails maximization of the Evidence Lower Bound (ELBO) criterion,

L_{V AE}(p,q)=E_{q(z|x)}[log p(x|z)]−D_{KL}[q(x|z)∥p(z)].

Where the first term is the reconstruction loss and the second one is the Kullback-Leibler divergence with respect to the prior distribution. Typically, the associated encoder q (z|x) and decoder q(x|z) functions are realized with Gaussians, whose parameters θp, θq are estimated using neural networks.

In order to facilitate the disentanglement of the private and public component, different multiple classification tasks may be used. To this end, a mapping may be defined based on a deep feed-forward architecture that takes as input the latent representation z and predicts a label y∈Y, defined as yy=g(z,θ), which is parameterized by θ. Specifically, we distinguish between public and private attributes Y_{*},Y_{•}, respectively. The first objective is to predict the public and private labels based on their section of the latent representation. That is, y̅_{*}=g_{*}(z_{*}; θ_{*}) and y̅_{•}=g_{•}(z_{•}; θ_{•}), with the associated loss terms, L_{θ}_{_{*}}(y_{*}, y̅_{*}), L_{θ}_{_{•}}(y_{•}, y̅_{•}), which can be realized with cross-entropy.

One solution would be to optimize the function comprising the VAE together with the classification terms, pushing for classification based on each latent sub-vector, yielding: E(θₚ, θ_{q}, θ_{*}, θ_{•})=λ_{V AE}·L_{V AE}+λ_{*}·L_{θ}_{_{*}}+λ_{•}·L_{θ}_{_{•}}, where λ∈ [symbol] represents a scaling parameter. However, following this notion leads to a presentation that does not fulfill z_{*}⊥z_{•}. That is, there is information leakage between the terms, particularly when the attributes to be classified are not strictly semantically disentangled. Generally speaking, the disentangled latent code should capture no more than one semantically meaningful factor of variation in the data with respect to private and public attributes. This is particularly problematic when there is excess information capacity in the bottleneck layer generating the latent representation.

Thus, in order to aid in disentanglement, label confusion terms are added. This entails adding additional classification terms. The underlying notion is that sensitive attributes should not be predictable from public ones. The follow-up step depends on the boundary conditions for learning the downstream tasks. Therefore, it may be decomposed into two variants. The first variant assumes that the downstream task is a priori known. This allows for an optimal disentanglement of public and private information, such that sensitive content is not compromised. On the other hand, if the downstream task is not a priori known, the objective is to learn a representation that does not contain sensitive information in the public part and yet is rich in terms of expressive power for a multitude of tasks.

For the first variant, the domain confusion classifiers can be defined according to

[symbol]

= [symbol] (z_{•}; [symbol] )

[symbol]

= [symbol] (z_{*}; [symbol] ),

which essentially assesses how well the private attribute can be derived from public latent part z_{*} and vice-versa. As it is desirable to publish classifiability in the confused sense, backpropagation in the negative gradient direction can be performed with respect to [symbol] and [symbol] .

This yields the following,

$$E ( {θ}_{p} , {θ}_{q} , {θ}_{*} , θ . ) = {λ}_{VAE} \cdot {L}_{VAE} + {\sum }_{i}^{2} {λ}_{i} \cdot {L}_{i} - {\sum }_{j}^{2} {λ}_{j} \cdot {L}_{j}$$

where the terms are simplified for the sake of economy in notation. In this case the information between the public and the private labels are not perfectly uncorrelated, optimization allows for trading off privacy versus performance by adjusting λ parameters, accordingly.

For the second variant, the downstream task is not known a priori. Only the client level information is provided. Therefore, a counter-directional optimization may be performed. That is, while promoting the classifiability of the private content in the private latent variable, the classifiability in the public latent variable is penalized. This is accomplished by adding a loss term with respect to the following classification objective, [symbol] = [symbol] (z_{*}; [symbol] ) to the VAE loss equation described earlier. This yields the following function:

E(θₚ,θ_{q},θ_{•})=λ_{V AE}·L_{V AE}+λ_{•}·L_{θ}_{_{•}}− [symbol] · [symbol] ,

which maximizes the information with respect to the sensitive label in the private latent part, and minimizes the information in the public latent part. This constraint is considerably weaker compared to that in the first variant. However, it provides a general representation in the absence of knowledge about future tasks. Furthermore, it assumes that the private and public are perfectly disentangled.

Optimization of the Joint Cost Functions E(θₚ, θ_{q}, θ_{*}, θ_{•})=λ_{V AE}·L_{V AE}+Σᵢ² Δᵢ·Lᵢ−Σⱼ²λⱼ·Lⱼ and E(θₚ, θ_{q}, θ_{•})=λ_{V AE}·L_{V AE}+λ_{•}·L_{θ}_{_{•}}− [symbol] · [symbol] is non-trivial. On the one hand, the confusion terms have a strong destructiveness. Giving too much emphasis on confusion bears the risk of eliminating all information and maximizing entropy. On the other hand, too much suppression of confusion undermines the privacy aspects and reduces to the naïve solution. To this end, an annealing scheme may be used. Specifically, in order to align the objectives, pretraining is performed without confusion. This allows the system to learn a stable representation that allows for gentle modification, i.e., channeling of the information flow. Subsequently, the scale factors λ_{*},λ_{•} may be lowered while [symbol] , [symbol] may be increased. Tapering off the classification objective scales with respect to the confusion avoids oscillations and facilitates stable learning behavior.

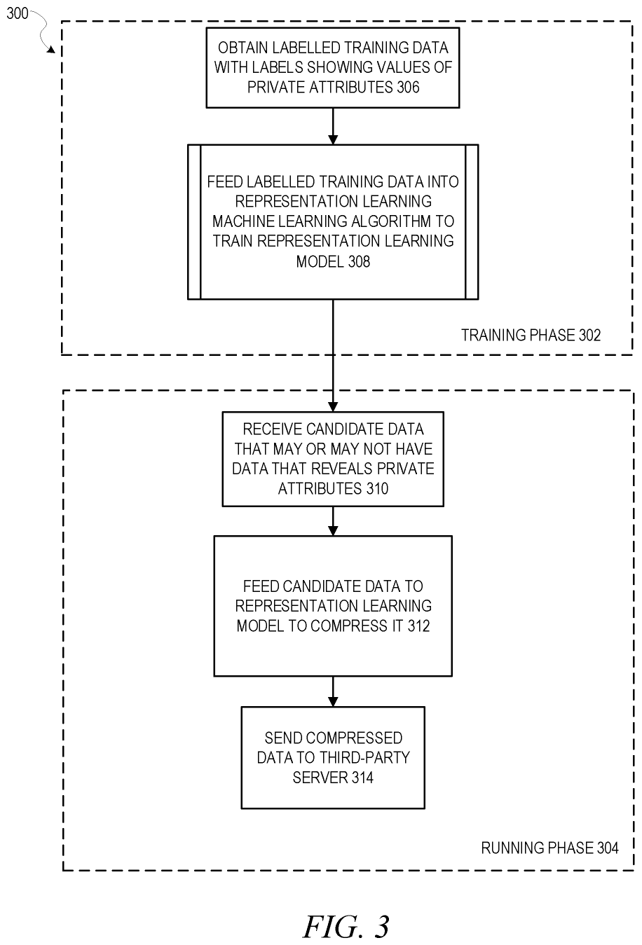

FIG. 3 is a flow diagram illustrating a method 300 for creating a privacy-preserving representation of data in accordance with an example embodiment. The method 300 may be broken out into two phases: a training phase 302 and a running phase 304. During the training phase 302, a representation learning model will be trained. During the running phase 304, the representation learning model will be used on input data to compress the input data in a manner such that private information, or information that could be used to deduce private information, cannot be decompressed.

At operation 306, labelled training data with labels showing values of private attributes are obtained. At operation 308, the labelled training data is fed into a machine learning algorithm to train a representation learning model to compress data in a manner such that private attributes cannot be decompressed. At this stage, what is happening is that the representation learning model is learning to sanitize data so that a classifier using the sanitized data can predict anything but the private attributes.

At operation 310, candidate data that may or may not have data that reveals private attributes may be received. At operation 312, the candidate data may be fed to the representation learning model, compressing it in a manner that cannot be used by a classifier to predict the private attributes. At operation 314, the compressed data is sent to a third-party server, where it could be used for another purpose, such as machine learning.

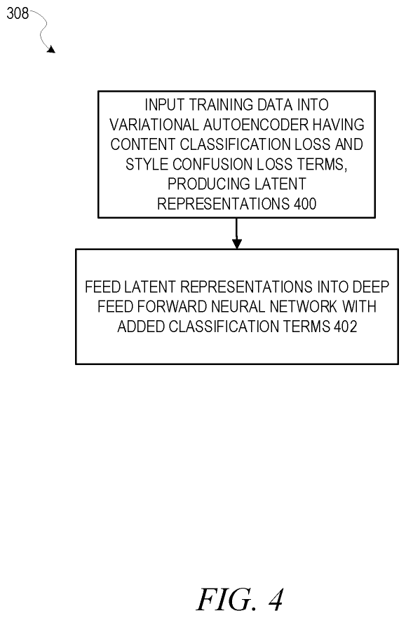

FIG. 4 is a flow diagram illustrating a method 308 for feeding the labelled training data into a machine learning algorithm to train a representation learning model to compress data in a manner such that private attributes cannot be decompressed, in accordance with an example embodiment. At operation 400, the training data are input into a variational autoencoder having content classification loss and style confusion loss terms, producing latent representations. Style captures the private aspects of the data, whereas content captures the public aspects. At operation 402, the latent representations are fed into a feed forward neural network with added classification terms. These added terms will depend upon whether the downstream task for the compressed version of the data is known a priori or not, as described in detail above. The feed forward neural network outputs the trained representation learning model.

### EXAMPLES

Example 1. A system comprising:

at least one hardware processor; and

a non-transitory computer-readable medium storing instructions that, when executed by the at least one hardware processor, cause the at least one hardware processor to perform operations comprising:

obtaining labelled training data having labels showing values of private attributes identifiable from the data;

passing the labelled training data into a variational autoencoder (VAE) having loss terms for a loss of predictability of private attributes from public information in the labelled training data and a loss of predictability of public attributes from the public information in the labelled training data, outputting a training representation;

feeding the training representation into a feed forward neural network to train the feed forward neural network to compress data while minimizing the loss of predictability of public attributes from the public information while also maximizing the loss of predictability of private attributes from the public information; and

maintaining the variational autoencoder and the feed forward neural network on a trusted server separate and distinct from a third-party server having a machine learning algorithm trained using data output by the feed forward neural network.

Example 2. The system of Example 1, wherein the operations further comprise:

receiving input data at the trusted server;

passing the input data through the variational autoencoder and the feed forward neural network, to output compressed data; and

passing the compressed data to the third-party server for use in training a machine learned model using the machine learning algorithm.

Example 3. The system of Example 2, wherein the operation further comprise:

obtaining domain confusion classifiers from the third-party server; and

backpropagating the domain confusion classifiers in a negative gradient direction in the feed forward neural network.

Example 4. The system of any of Examples 1-3, wherein the VAE assumes isotropic Gaussian as latent prior.
Example 5. The system of any of Examples 1-4, wherein pretraining of the feed forward neural network is performed without confusion terms.
Example 6. The system of any of Examples 1-5, wherein the feed forward neural network is gradually trained having scale factors for classification terms pertaining to the loss of predictability of the feed forward neural network for minimizing the loss of predictability of public attributes from the public information and maximizing the loss of predictability of private attributes from the public information gradually increase over time.
Example 7. The system of any of Examples 2-3, wherein the input data is medical data.
Example 8. A method comprising:

obtaining labelled training data having labels showing values of private attributes identifiable from the data;

passing the labelled training data into a variational autoencoder (VAE) having loss terms for a loss of predictability of private attributes from public information in the labelled training data and a loss of predictability of public attributes from the public information in the labelled training data, outputting a training representation;

feeding the training representation into a feed forward neural network to train the feed forward neural network to compress data while minimizing the loss of predictability of public attributes from the public information while also maximizing the loss of predictability of private attributes from the public information; and

maintaining the variational autoencoder and the feed forward neural network on a trusted server separate and distinct from a third-party server having a machine learning algorithm trained using data output by the feed forward neural network.

Example 9. The method of Example 8, further comprising:

receiving input data at the trusted server;

passing the input data through the variational autoencoder and the feed forward neural network, to output compressed data; and

passing the compressed data to the third-party server for use in training a machine learned model using the machine learning algorithm.

Example 10. The method of Example 9, further comprising:

obtaining domain confusion classifiers from the third-party server; and

backpropagating the domain confusion classifiers in a negative gradient direction in the feed forward neural network.

Example 11. The method of any of Examples 8-10, wherein the VAE assumes isotropic Gaussian as latent prior.
Example 12. The method of any of Examples 8-11, wherein pretraining of the feed forward neural network is performed without confusion terms.
Example 13. The method of any of Examples 8-12, wherein the feed forward neural network is gradually trained having scale factors for classification terms pertaining to the loss of predictability of the feed forward neural network for minimizing the loss of predictability of public attributes from the public information and maximizing the loss of predictability of private attributes from the public information gradually increase over time.
Example 14. The method of any of Examples 9-10, wherein the input data is medical data.
Example 15. A non-transitory machine-readable medium storing instructions which, when executed by one or more processors, cause the one or more processors to perform operations comprising:

obtaining labelled training data having labels showing values of private attributes identifiable from the data;

passing the labelled training data into a variational autoencoder (VAE) having loss terms for a loss of predictability of private attributes from public information in the labelled training data and a loss of predictability of public attributes from the public information in the labelled training data, outputting a training representation;

feeding the training representation into a feed forward neural network to train the feed forward neural network to compress data while minimizing the loss of predictability of public attributes from the public information while also maximizing the loss of predictability of private attributes from the public information; and maintaining the variational autoencoder and the feed forward neural network on a trusted server separate and distinct from a third-party server having a machine learning algorithm trained using data output by the feed forward neural network.

Example 16. The non-transitory machine-readable medium of Example 15, wherein the operations further comprise:

receiving input data at the trusted server;

passing the input data through the variational autoencoder and the feed forward neural network, to output compressed data; and

passing the compressed data to the third-party server for use in training a machine learned model using the machine learning algorithm.

Example 17. The non-transitory machine-readable medium of Example 16, wherein the operation further comprise:

obtaining domain confusion classifiers from the third-party server; and

backpropagating the domain confusion classifiers in a negative gradient direction in the feed forward neural network.

Example 18. The non-transitory machine-readable medium of any of Examples 15-17, wherein the VAE assumes isotropic Gaussian as latent prior.
Example 19. The non-transitory machine-readable medium of any of Examples 15-18, wherein pretraining of the feed forward neural network is performed without confusion terms.
Example 20. The non-transitory machine-readable medium of any of Examples 15-19, wherein the feed forward neural network is gradually trained having scale factors for classification terms pertaining to the loss of predictability of the feed forward neural network for minimizing the loss of predictability of public attributes from the public information and maximizing the loss of predictability of private attributes from the public information gradually increase over time.

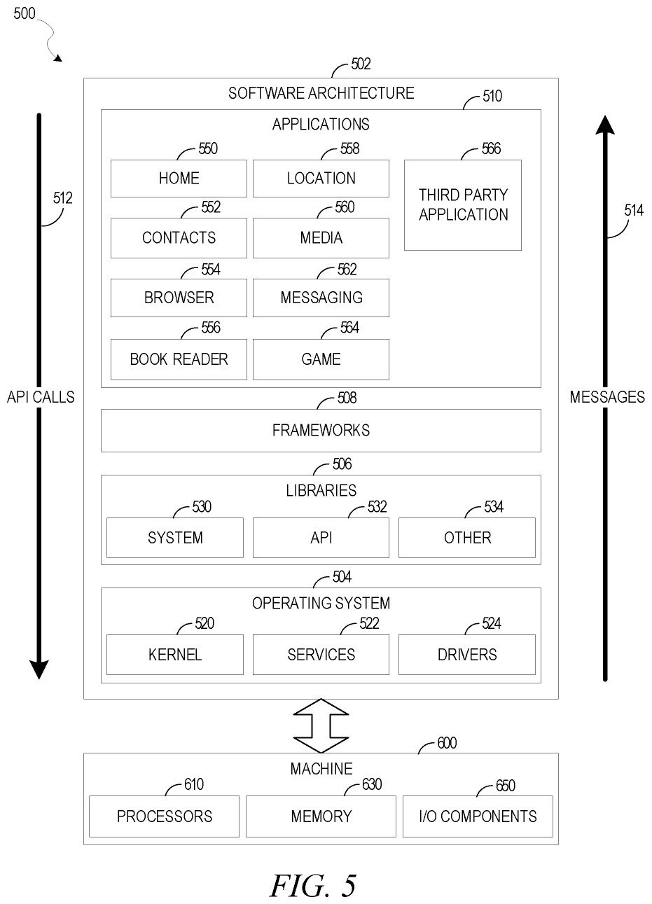

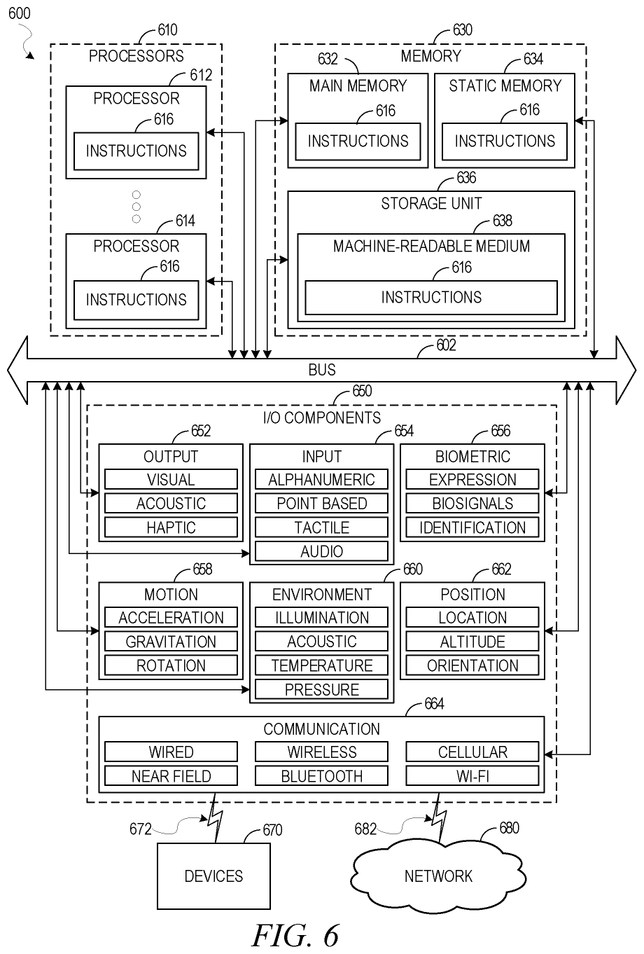

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various graphical user interface (GUI) functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the methods of FIGS. 3-4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or include components operable to detect identifiers. For example, the communication components 664 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (i.e., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., Hypertext Transfer Protocol (HTTP)). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a non-transitory computer-readable medium storing instructions that, when executed by the at least one hardware processor, cause the at least one hardware processor to perform operations comprising:
obtaining labelled training data having labels showing values of private attributes identifiable from the data;
passing the labelled training data into a variational autoencoder (VAE) having loss terms for a loss of predictability of private attributes from public information in the labelled training data and a loss of predictability of public attributes from the public information in the labelled training data, outputting a training representation;
feeding the training representation into a feed forward neural network to train the feed forward neural network to compress data while minimizing the loss of predictability of public attributes from the public information while also maximizing the loss of predictability of private attributes from the public information; and
maintaining the variational autoencoder and the feed forward neural network on a trusted server separate and distinct from a third-party server having a machine learning algorithm trained using data output by the feed forward neural network.

2. The system of claim 1, wherein the operations further comprise:
receiving input data at the trusted server;
passing the input data through the variational autoencoder and the feed forward neural network, to output compressed data; and
passing the compressed data to the third-party server for use in training a machine learned model using the machine learning algorithm.

3. The system of claim 2, wherein the operation further comprise:
obtaining domain confusion classifiers from the third-party server; and
backpropagating the domain confusion classifiers in a negative gradient direction in the feed forward neural network.

4. The system of claim 1, wherein the VAE assumes isotropic Gaussian as latent prior.

5. The system of claim 1, wherein pretraining of the feed forward neural network is performed without confusion terms.

6. The system of claim 1, wherein the feed forward neural network is gradually trained having scale factors for classification terms pertaining to the loss of predictability of the feed forward neural network for minimizing the loss of predictability of public attributes from the public information and maximizing the loss of predictability of private attributes from the public information gradually increase over time.

7. The system of claim 2, wherein the input data is medical data.

8. A method comprising:
obtaining labelled training data having labels showing values of private attributes identifiable from the data;
passing the labelled training data into a variational autoencoder (VAE) having loss terms for a loss of predictability of private attributes from public information in the labelled training data and a loss of predictability of public attributes from the public information in the labelled training data, outputting a training representation;
feeding the training representation into a feed forward neural network to train the feed forward neural network to compress data while minimizing the loss of predictability of public attributes from the public information while also maximizing the loss of predictability of private attributes from the public information; and
maintaining the variational autoencoder and the feed forward neural network on a trusted server separate and distinct from a third-party server having a machine learning algorithm trained using data output by the feed forward neural network.

9. The method of claim 8, further comprising:
receiving input data at the trusted server;
passing the input data through the variational autoencoder and the feed forward neural network, to output compressed data; and
passing the compressed data to the third-party server for use in training a machine learned model using the machine learning algorithm.

10. The method of claim 9, further comprising:
obtaining domain confusion classifiers from the third-party server; and
backpropagating the domain confusion classifiers in a negative gradient direction in the feed forward neural network.

11. The method of claim 8, wherein the VAE assumes isotropic Gaussian as latent prior.

12. The method of claim 8, wherein pretraining of the feed forward neural network is performed without confusion terms.

13. The method of claim 8, wherein the feed forward neural network is gradually trained having scale factors for classification terms pertaining to the loss of predictability of the feed forward neural network for minimizing the loss of predictability of public attributes from the public information and maximizing the loss of predictability of private attributes from the public information gradually increase over time.

14. The method of claim 9, wherein the input data is medical data.

15. A non-transitory machine-readable medium storing instructions which, when executed by one or more processors, cause the one or more processors to perform operations comprising:
obtaining labelled training data having labels showing values of private attributes identifiable from the data;
passing the labelled training data into a variational autoencoder (VAE) having loss terms for a loss of predictability of private attributes from public information in the labelled training data and a loss of predictability of public attributes from the public information in the labelled training data, outputting a training representation;
feeding the training representation into a feed forward neural network to train the feed forward neural network to compress data while minimizing the loss of predictability of public attributes from the public information while also maximizing the loss of predictability of private attributes from the public information; and
maintaining the variational autoencoder and the feed forward neural network on a trusted server separate and distinct from a third-party server having a machine learning algorithm trained using data output by the feed forward neural network.

16. The non-transitory machine-readable medium of claim 15, wherein the operations further comprise:
receiving input data at the trusted server;
passing the input data through the variational autoencoder and the feed forward neural network, to output compressed data; and
passing the compressed data to the third-party server for use in training a machine learned model using the machine learning algorithm.

17. The non-transitory machine-readable medium of claim 16, wherein the operation further comprise:
obtaining domain confusion classifiers from the third-party server; and
backpropagating the domain confusion classifiers in a negative gradient direction in the feed forward neural network.

18. The non-transitory machine-readable medium of claim 15, wherein the VAE assumes isotropic Gaussian as latent prior.

19. The non-transitory machine-readable medium of claim 15, wherein pretraining of the feed forward neural network is performed without confusion terms.

20. The non-transitory machine-readable medium of claim 15, wherein the feed forward neural network is gradually trained having scale factors for classification terms pertaining to the loss of predictability of the feed forward neural network for minimizing the loss of predictability of public attributes from the public information and maximizing the loss of predictability of private attributes from the public information gradually increase over time.
